(19) United States
(12) Patent Application Publication
(10) Pub. No.: US 2026/0076353 A1
(43) Pub. Date: Mar. 19, 2026

(54) LURE

(71) Applicant: Shimano Inc., Osaka (JP)

(72) Inventor: Kimio KOKUGA, Osaka (JP)

(21) Appl. No.: 19/282,752

(22) Filed: Jul. 28, 2025

(30) Foreign Application Priority Data
Sep. 13, 2024 (JP) 2024-158741

(51) Int. Cl. A01K 85/00

(52) U.S. Cl. CPC A01K 85/1867

(57) ABSTRACT

A lure comprises a plurality of line eyes. The plurality of line eyes can be connected to a line. The plurality of line eyes are connected to each other via a communication hole.

### CROSS-REFERENCE TO RELATED APPLICATIONS

This application claims priority to Japanese Patent Application No. 2024-158741, filed on Sep. 13, 2024. The entire disclosure of Japanese Patent Application No. 2024-158741 is hereby incorporated by reference.

### BACKGROUND

### Technical Field

The present disclosure relates to a lure.

### Background Information

U.S. Pat. No. 4,215,507 discloses a lure in which it is possible to adjust the position of a line eye in the forward-rearward direction with respect to a lure body. In the lure of U.S. Pat. No. 4,215,507, a plate-like member having a line eye is moved in the forward-rearward direction and the plate-like member is fixed to the lure body with a screw to adjust the position of the line eye with respect to the lure body. The connection position of the line relative to the lure is thereby adjusted.

### SUMMARY

It has been determined that in the lure of U.S. Pat. No. 4,215,507, when the screw is loosened, displacement in the position of the plate-like member relative to the lure body in the forward-rearward direction is possible. That is, the line connection position relative to the lure may be displaced from the position desired by a user.

In contrast, in the lure of Japanese Laid Open Patent Application No. 2002-176883, a plurality of line eyes are provided, and the line connection position can be changed by changing the line eye to which the line is connected.

However, it has been determined that in a lure provided with a plurality of line eyes, when changing the line connection position, the user must remove a snap that connects the line and the line eye, for example. Therefore, the task of changing the line connection position is difficult.

One object of the present disclosure is to provide a lure that prevents the line connection position from being displaced from the desired position and that facilitates the task of changing the line connection position.

The lure of a first aspect of the present disclosure comprises a plurality of line eyes. The plurality of line eyes can be connected to a line. The plurality of line eyes are connected to each other via a communication hole.

According to the lure of the first aspect, the line connection position with respect to the lure can be changed by changing the line eye to which the line is connected. By providing the lure with a plurality of line eyes to which a line can be connected, it is possible to prevent the line eye from changing during the use of the lure, for example. Therefore, the lure can achieve a user's desired movement in water. The user can change the line eye to which the line is connected via the communication hole. Therefore, the user can easily change the line eye to which the line is connected.

In a lure of a second aspect according to the first aspect, the communication hole is connected to the lower ends of the plurality of line eyes.

According to the lure of the second aspect, when the lure is used, a tensile force is applied by the line one a side of the line eye in a direction different from side having the communication hole. Therefore, the lure can prevent, for example, a ring member that connects the line and the line eye from entering into the communication hole during use of the lure. That is, the lure can prevent the line eye to which the line is connected from changing during use of the lure. Accordingly, the lure can achieve a user's desired movement in water.

A lure of a third aspect according to the first or second aspect comprises a partition wall. Partition walls can be formed between the plurality of line eyes and are configured to separate the plurality of line eyes. The length of each of the partition walls in the upward-downward direction is shorter than the inner diameter of the ring member connecting the line eye and the line.

According to the lure of the third aspect, the partition walls can prevent the ring member from moving between the plurality of line eyes. Therefore, the lure can prevent the line eye to which the line is connected from changing during use of the lure. Accordingly, the lure can achieve a user's desired movement in water. The user can move the ring member such that the partition wall passes therethrough to change the line eye to which the ring member is attached. That is, the user can easily change the line eye to which the line is connected.

A lure of a fourth aspect according to any one of the first to the third aspects comprises a partition wall. Partition walls can be formed between the plurality of line eyes and are configured to separate the plurality of line eyes. Each of the partition walls has a protrusion protruding in the forward-rearward direction from the lower end of the partition wall.

According to the lure of the fourth aspect, the protrusion can prevent, for example, a ring member connecting a line eye and the line from entering the communication hole. Therefore, the lure can prevent the line eye to which the line is connected from changing during use of the lure. Accordingly, the lure can achieve a user's desired movement in water.

A lure of a fifth aspect according to any one of the first to the fourth aspects comprises a partition wall. Partition walls can be formed between the plurality of line eyes and are configured to separate the plurality of line eyes. Each of the line eyes has a protrusion protruding toward the partition wall.

According to the lure of the fifth aspect, the protrusion can prevent, for example, a ring member connecting a line eye and the line from entering the communication hole. Therefore, the lure can prevent the line eye to which the line is connected from changing during use of the lure. Accordingly, the lure can achieve a user's desired movement in water.

A lure of a sixth aspect according to any one of the first to the fifth aspects comprises a plate member and a body. The plate member has a plurality of line eyes. The plate member is attached to the body. A slit that is connected to the communication hole is formed in the plate member. The slit is enclosed in the body.

According to the lure of the sixth aspect, when manufacturing the lure, the ring member connecting a line and a line eye can be attached to the line eye via the slit and the communication hole. Therefore, the task of attaching the ring member to a line eye is facilitated. After the ring member is attached to the line eye, because the slit is enclosed in the body, the lure can prevent the ring member from falling off via the slit.

A lure of a seventh aspect according to any one of the first to the sixth aspects comprises a plate member, a body, and an elastic member. The plate member includes the plurality of line eyes. The plate member is attached to the body. The elastic member is supported by the body. The elastic member is configured to prevent the ring member connecting a line and a line eye from moving to the communication hole.

According to the lure of the seventh aspect, the elastic member can prevent the ring member from moving to the communication hole. Therefore, the lure can prevent the line eye to which the line is connected from changing during use of the lure. Accordingly, the lure can achieve a user's desired movement in water. The user can, for example, push the ring member down and elastically deform the elastic member to change the line eye to which the ring member is attached.

A lure of an eighth aspect according to any one of the first to the seventh aspects comprises an elastic body. The elastic body is configured to protrude into the communication hole.

According to the lure of the eighth aspect, the elastic body can prevent the ring member connecting a line and a line eye from moving through the communication hole. Therefore, the lure can prevent the line eye to which the line is connected from changing during use of the lure. Accordingly, the lure can achieve a user's desired movement in water. The user can, for example, elastically deform the elastic body with the ring member in the communication hole to move the ring member and change the line eye to which the ring member is attached.

A lure according to a ninth aspect according to any one of the first to the eighth aspects comprises a plate member and a body. The plate member has a plurality of line eyes. The plate member is attached to the body. The plate member is elastically deformable in the upward-downward direction with respect to the body.

According to the lure of the ninth aspect, when the plate member is elastically deformed upward, the plurality of line eyes move upward with respect to the body. As a result, for example, at least some of the plurality of line eyes protrude from the body. Therefore, the user can easily change the line eye to which the line is connected.

In a lure of a tenth aspect according to the ninth aspect, an end of the plate member on the side opposite to the plurality of line eyes in the upward-downward direction protrudes downward from the body.

According to the lure of the tenth aspect, the user can press the end of the plate member protruding downward from the body upward to elastically deform the plate member upward. As a result, the user can cause at least some of the plurality of line eyes to protrude from the body to change the line eye to which the line is connected. Therefore, the user can easily change the line eye to which the line is connected.

In a lure of an eleventh aspect according to the ninth or tenth aspect, a slit that is connected to the communication hole is formed in the plate member. The body has a protrusion that is inserted into the slit.

According to the lure of the eleventh aspect, when the plate member is elastically deformed upward, the protrusion prevents the width of the slit from becoming too narrow. That is, the lure can prevent narrowing of the width of the communication hole when the plate member is elastically deformed upward. As a result, the user can easily move the ring member connecting a line and a line eye inside the communication hole, even when the plate member is elastically deformed upward. Therefore, the user can easily change the line eye to which the line is connected.

In a lure of a twelfth aspect according to any one of the ninth to the eleventh aspects, a slit that is connected to the communication hole is formed in the plate member. A plurality of recesses are formed in a lower piece of the plate member in which the slit is formed.

According to the lure of the twelfth aspect, when the plate member is elastically deformed upward, the lower piece is elastically deformed where the plurality of recesses are formed. That is, when the plate member is elastically deformed upward, the locations of deformation in the lower piece can be dispersed while limiting the locations that deform in the lower piece. As a result, the lure can prevent deformation in plastic locations where deformation is not desirable in the plate member. By providing a plurality of recesses, the lure can disperse the locations where stress is concentrated when the plate member is elastically deformed. As a result, the lure can prevent damage to the plate member that is elastically deformed upward. The user can elastically deform the plate member upward with a small force. Therefore, the user can easily change the line eye to which the line is connected.

According to the lure of the present disclosure, it is possible to prevent the line connection position from being displaced from the desired position and facilitate the task of changing the line connection position.

### BRIEF DESCRIPTION OF THE DRAWINGS

FIG. 1 is a side view of a lure according to a first embodiment.

FIG. 2 is a plan view of the lure according to the first embodiment.

FIG. 3 is a side view of a first body part according to the first embodiment as viewed from a second body part side.

FIG. 4 is a side view of the second body part according to the first embodiment as viewed from the first body part side.

FIG. 5 is a cross-sectional view taken along line V-V in FIG. 2.

FIG. 6 is a cross-sectional view taken along line VI-VI in FIG. 2.

FIG. 7 is a cross-sectional view taken along line VII-VII in FIG. 2.

FIG. 8 is an enlarged view of a front side of the lure in FIG. 7.

FIG. 9 is a diagram explaining a lure according to a modified example.

FIG. 10 is a diagram explaining a lure according to a modified example.

FIG. 11 is a plan view showing the front side of a lure according to the second embodiment.

FIG. 12 is an enlarged side view of the front side of the lure according to the second embodiment, with the second body part omitted.

FIG. 13 is a side view of the front side of the first body part according to the second embodiment as viewed from a second body part side.

FIG. 14 is a side view of the front side of the second body part according to the second embodiment as viewed from a first body part side.

FIG. 15 is a perspective view of an elastic member according to the second embodiment.

FIG. 16 is a diagram explaining a lure according to a modified example.

FIG. 17 is an enlarged side view of the front side of the lure according to the third embodiment, with the second body part omitted.

FIG. 18 is an enlarged side view of the front side of the lure according to the third embodiment, with the first body part omitted.

### DETAILED DESCRIPTION

### Embodiment 1

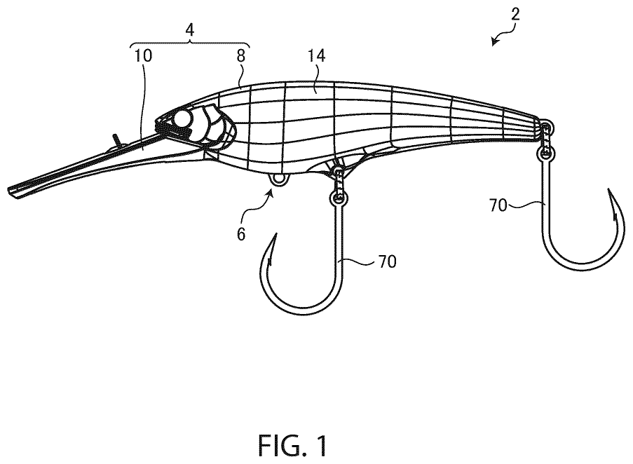

A lure 2 according to the first embodiment will be described with reference to FIGS. 1-7. The lure 2 is, for example, a lure for catching large fish (fish eaters) that prey on small fish. Examples of large fish include largemouth bass, yellowtail, juvenile yellowtail, and sea bass. The lure 2 has a shape resembling a small fish.

In this Specification, terms indicating the directions “front,” “rear,” “forward (front side),” “rearward (rear side),” “left,” “right,” “leftward,” “rightward,” “up,” “down,” “upward,”“downward,”as well as any other similar direction, are defined as follows.

“Front” and “forward (front side)” indicate the direction of travel in which the lure 2 travels while being pulled by a line (fishing line) to which the lure 2 is connected. “Rear” and “rearward (rear side)” are directions opposite to the direction of travel. “Forward-rearward direction”corresponds to the longitudinal direction of the lure 2.

“Up” and “upward” indicate the direction toward the surface of the water when the lure 2 is moving forward in the water. “Down” and “downward” indicate the direction toward the bottom of the water when the lure 2 is moving forward in the water. “Left,” “leftward,”“right,”and “rightward”are defined based on “up”and “down”.

As shown in FIG. 1, the lure 2 comprises a body 4 and a plate member 6. The body 4 is formed so as to extend in the forward-rearward direction. The body 4 is made of resin. The body 4 has a body portion 8 and a lip 10. The body portion 8 is formed to match the shape of a small fish. The lip 10 is formed so as to protrude forward from the front end of the body portion 8.

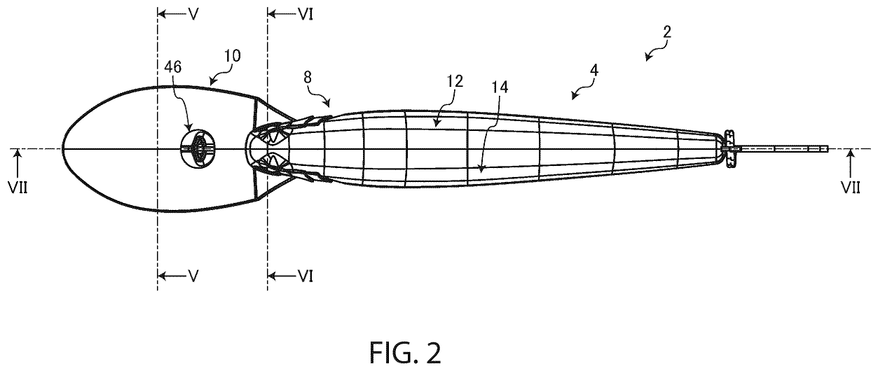

As shown in FIG. 2, the body 4 includes a first body part 12 and a second body part 14. The body 4 is divided into the first body part 12 and the second body part 14 in the left-right direction. The body 4 is formed by joining the first body part 12 and the second body part 14. In other words, the body 4 can be split in to two halves in the left-right direction. The first half being the first body part 12 and the second half being the second body part 14.

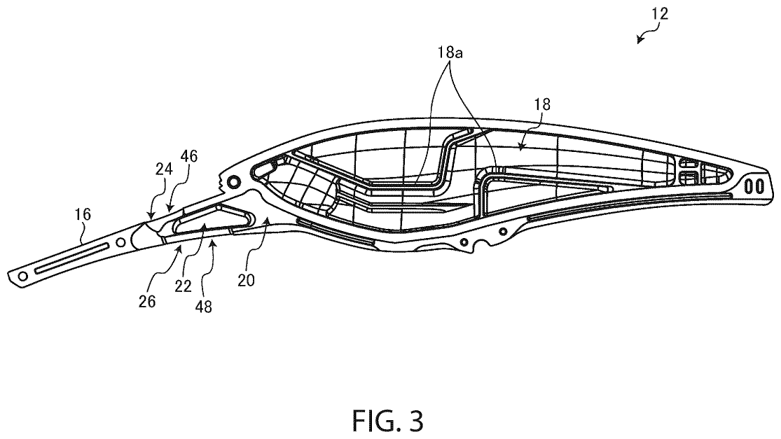

As shown in FIG. 3, the first body part 12 has a protrusion 16. The protrusion 16 is formed on the front side of the first body part 12. When the body 4 is formed, the protrusion 16 constitutes the lip 10 (refer to FIG. 2). A first recess 18, a second recess 20, and a third recess 22 are formed in the first body part 12. A first communication hole 24 and a second communication hole 26 are formed in the first body part 12.

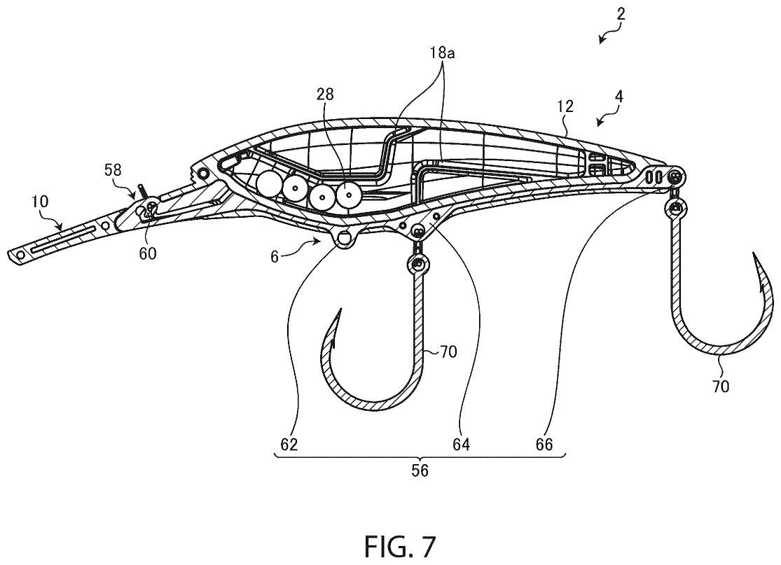

The first recess 18 is formed so as to be recessed rightward relative to the second body part 14 (refer to FIG. 2) side. The first recess 18 is formed extending in the forward-rearward direction. Guide walls 18a are formed in the first recess 18. The guide walls 18a are formed so as to guide the movement of a weight 28 (refer to FIG. 7). The guide walls 18a are formed such that the weight 28 moves rearward when the lure 2 is cast. The guide walls 18a are formed such that the weight 28 moves forward when the lure 2 hits water. The lure 2 can be configured such that the body 4 does not accommodate the weight 28.

The second recess 20 is formed so as to be recessed rightward relative to the second body part 14 side. The second recess 20 is formed so as to pass below the first recess 18 and extend in the forward-rearward direction. Specifically, the second recess 20 is formed extending from the protrusion 16 to the rear end.

The third recess 22 is formed so as to be further recessed rightward relative to the second recess 20 on the front side. At least a portion of the third recess 22 is formed in the protrusion 16.

The first communication hole 24 is formed in the protrusion 16. The first communication hole 24 is formed so as to be opened in the upward direction. The lower end of the first communication hole 24 is connected to the third recess 22. The first communication hole 24 is formed so as to widen in the upward direction.

The second communication hole 26 is formed in the protrusion 16. The second communication hole 26 is formed so as to be opened in the downward direction. The upper end of the second communication hole 26 is connected to the third recess 22.

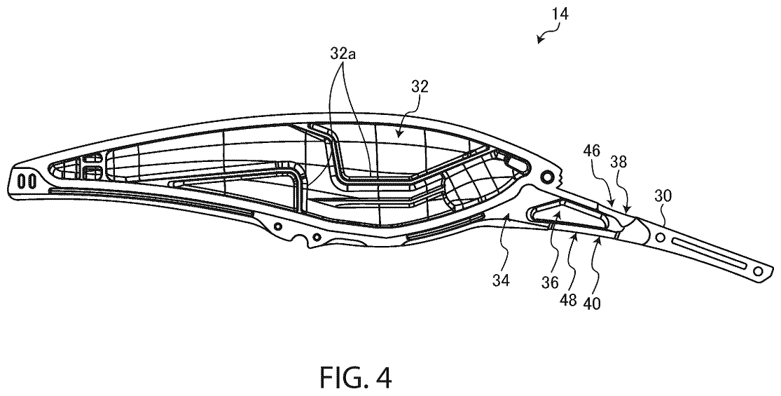

As shown in FIG. 4, the second body part 14 has a protrusion 30. The protrusion 30 is formed on the second body part 14 on the front side. When the body 4 is formed, the protrusion 30 constitutes the lip 10 (refer to FIG. 2). A first recess 32, a second recess 34, and a third recess 36 are formed in the second body part 14. A first communication hole 38 and a second communication hole 40 are formed in the second body part 14.

The first recess 32 is formed so as to be recessed leftward from the first body part 12 (refer to FIG. 2) side. The first recess 32 is formed extending in the forward-rearward direction. Guide walls 32a are formed in the first recess 32. The guide walls 32a are formed so as to guide the movement of the weight 28 (refer to FIG. 7), in the same manner as the guide walls 18a formed in the first recess 18 of the first body part 12.

The second recess 34 is formed so as to be recessed leftward relative to the first body part 12 side. The second recess 34 is formed so as to pass below the first recess 32 and extend in the forward-rearward direction. Specifically, the second recess 34 is formed extending from the protrusion 30 to the rear end.

The third recess 36 is formed so as to be further recessed leftward relative to the second recess 34 on the front side. At least a portion of the third recess 36 is formed in the protrusion 30.

The first communication hole 38 is formed in the protrusion 30. The first communication hole 38 is formed so as to be opened in the upward direction. The lower end of the first communication hole 38 is connected to the third recess 36. The first communication hole 38 is formed so as to widen in the upward direction.

The second communication hole 40 is formed in the protrusion 30. The second communication hole 40 is formed so as to be opened in the downward direction. The upper end of the second communication hole 40 is connected to the third recess 36.

The first body part 12 and the second body part 14 are joined by ultrasonic welding, for example. The first body part 12 and the second body part 14 can be bonded to each other. When the first body part 12 and the second body part 14 are joined, the first communication holes 24, 38 form a first communication hole 46. Similarly, the second communication holes 26, 40 form a second communication hole 48.

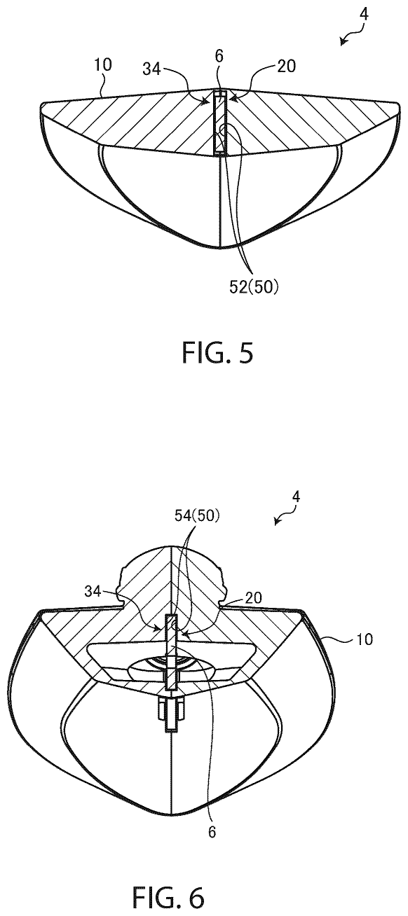

As shown in FIGS. 5 and 6, the body 4 has a restricting portion 50. The restricting portion 50 restricts the movement of the plate member 6 relative to the body 4. The restricting portion 50 has a first restricting part 52 and a second restricting part 54. As shown in FIG. 5, the first restricting part 52 sandwiches the plate member 6 on the front side of a plurality of line eyes 58, described further below. The first restricting part 52 sandwiches the plate member 6 from the left and right directions. Specifically, the first restricting part 52 is formed by the left and right side walls in the second recesses 20, 34.

As shown in FIG. 6, the second restricting part 54 sandwiches the plate member 6 on the rear side the plurality of line eyes 58, described further below. The second restricting part 54 sandwiches the plate member 6 from the left and right directions. Specifically, the second restricting part 54 is formed by the left and right side walls in the second recesses 20, 34.

As shown in FIG. 7, the plate member 6 is a plate-like member. The plate member 6 is made of metal. The plate member 6 is attached to the body 4. Specifically, the plate member 6 is disposed in the second recess 20 (refer to FIG. 3) of the first body part 12 and the second recess 34 (refer to FIG. 4) of the second body part 14. The plate member 6 is provided at the center of the body 4 in the left-right direction.

The plate member 6 is provided with a plurality of hook eyes 56. The plate member 6 includes a plurality of line eyes 58. The plate member 6 includes a partition wall 60.

The plurality of hook eyes 56 include a first hook eye 62, a second hook eye 64, and a third hook eye 66. A hook 70 can be connected to the plurality of hook eyes 56. FIG. 7 shows an example in which two hooks 70 are connected to the second hook eye 64 and the third hook eye 66.

The first hook eye 62 and the second hook eye 64 are protrude downward. The third hook eye 66 protrudes rearward. The number of the hook eyes 56 is not limited to three. The number of the hook eyes 56 may be two. The number of the hook eyes 56 can be four or more. The plate member 6 can include one hook eye 56.

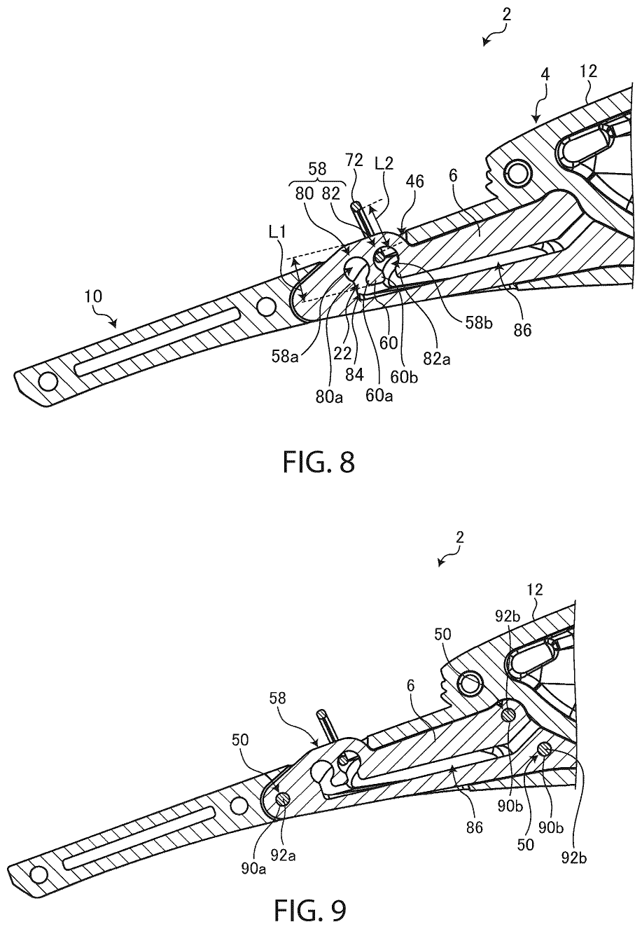

The plurality of line eyes 58 are provided forward of the plurality of hook eyes 56. The plurality of line eyes 58 are formed in the plate member 6 on the front side. As shown in FIG. 8, the plurality of line eyes 58 are provided on the lip 10. Specifically, the plurality of line eyes 58 are disposed in the third recesses 22, 36 (refer to FIG. 4) and the first communication hole 46. The plurality of line eyes 58 are provided such that the upper portions of the plurality of line eyes 58 protrude upward from the first communication hole 46.

The plurality of line eyes 58 are arranged side by side in the forward-rearward direction. For example, in one embodiment two line eyes 58 can be provided. In this embodiment, the plurality of line eyes 58 include a first line eye 80 and a second line eye 82. The number of the line eyes 58 is not limited to two. Three or more of the line eyes 58 can be provided. A line can be connected to the plurality of line eyes 58. Specifically, a line can be connected to the line eyes 58 via a ring member 72. The plurality of line eyes 58 are formed by a plurality of holes 58a, 58b formed in the plate member 6. That is, a plurality of holes 58a, 58b into which the ring member 72 can be inserted are formed in the plate member 6. The plurality of line eyes 58 are connected to each other via a communication hole 84.

The first line eye 80 is formed forward of the second line eye 82. The first line eye 80 has a protrusion 80a. The protrusion 80a protrudes toward the partition wall 60. Specifically, the protrusion 80a protrudes rearward. The protrusion 80a is formed at the lower end of the first line eye 80.

The second line eye 82 has a protrusion 82a. The protrusion 82a protrudes toward the partition wall 60. Specifically, the protrusion 82a protrudes in the forward direction. The protrusion 82a is formed at the lower end of the second line eye 82.

The partition wall 60 is formed between the plurality of line eyes 58. The partition wall 60 is configured to separate the plurality of line eyes 58. Specifically, the partition wall 60 is configured to separate the hole 58a forming the first line eye 80 and the hole 58b forming the second line eye 82. The partition wall 60 is formed as a result of the plurality of holes 58a, 58b being formed in the plate member 6. A length L1 of the partition wall 60 in the upward-downward direction is shorter than an inner diameter L2 of the ring member 72. The length L1 of the partition wall 60 is the length from the upper end surfaces of the plurality of line eyes 58 to the lower end of the partition wall 60. The partition wall 60 has a first protrusion 60a and a second protrusion 60b. The first protrusion 60a and the second protrusion 60b protrude in the forward-rearward direction from the lower end of the partition wall 60.

The first protrusion 60a protrudes forward from the lower end of the partition wall 60. The first protrusion 60a is formed so as to face the protrusion 80a of the first line eye 80. The second protrusion 60b protrudes in the rearward direction from the lower end of the partition wall 60. The second protrusion 60b is formed so as to face the protrusion 82a of the second line eye 82.

The plate member 6 can include just one of the protrusion 80a of the first line eye 80 or the first protrusion 60a of the partition wall 60. The plate member 6 can include just one of the protrusion 82a of the second line eye 82 or the second protrusion 60b of the partition wall 60.

The communication hole 84 is formed in the plate member 6. A slit 86 is formed in the plate member 6. The communication hole 84 is formed extending in the forward-rearward direction. The communication hole 84 is formed so as to pass below the partition wall 60. The communication hole 84 is connected to the plurality of line eyes 58. The communication hole 84 is connected to the lower ends of the plurality of line eyes 58. Specifically, the communication hole 84 is connected to the lower ends of the plurality of holes 58a, 58b forming the plurality of line eyes 58.

The slit 86 is connected to the communication hole 84. Specifically, the slit 86 is connected to the rear end of the communication hole 84. That is, the slit 86 is connected to the plurality of line eyes 58 via the communication hole 84. The slit 86 is formed extending in the rearward direction from the communication hole 84. The slit 86 is formed so as to be opened at the rear end.

When manufacturing the lure 2, the ring member 72 is inserted into the slit 86 from the opening formed at the rear end of the slit 86. The ring member 72 is inserted into the communication hole 84 from the slit 86. The ring member 72 is inserted from the communication hole 84 into either one of the holes 58a and 58b forming the plurality of line eyes 58. The ring member 72 is thereby attached to any one of the plurality of line eyes 58.

Next, the plate member 6 to which the ring member 72 is attached is disposed in the second recess 20 of the first body part 12 or the second recess 34 of the second body part 14. The weight 28 is disposed in the second recess 20 of the first body part 12 or the second recess 34 of the second body part 14.

Next, the first body part 12 and the second body part 14 are joined together to produce the lure 2. When the first body part 12 and the second body part 14 are joined together, the slit 86 is enclosed in the body 4. The ring member 72 can be attached to any one of the plurality of line eyes 58 after the first body part 12 and the second body part 14 are joined together.

When changing the line eye 58 to which the ring member 72 is attached, the user inserts the ring member 72 into the communication hole 84 from the original line eye 58. Next, the user moves the ring member 72 along the communication hole 84 and inserts the ring member 72 into the line eye 58 from the communication hole 84. In this manner, the user changes the line eye 58 to which the ring member 72 is attached via the communication hole 84.

The plate member 6 is sandwiched in the left and right directions by the restricting portion 50. Since the plate member 6 is sandwiched by the restricting portion 50, the rigidity of the line eye 58 increases against external force such as the tensile force of the line. As a result, deformation, etc., of the line eye 58 is suppressed even if an external force is applied to the line eye 58.

In the lure 2 according to a modified example, a first hole 90a and second holes 90b are formed in the plate member 6, as shown in FIG. 9. The first hole 90a is formed forward of the plurality of line eyes 58. The second holes 90b are formed rearward of the plurality of line eyes 58. A plurality of the second holes 90b are formed. For example, two of the second holes 90b are formed. The second holes 90b are formed above the slit 86 as well as below the slit 86. The number of the second holes 90b can be one.

The restricting portion 50 includes a first pin 92a and second pins 92b. The first pin 92a is formed forward of the plurality of line eyes 58. The first pin 92a is configured to protrude from a side wall of the second recess 20 (refer to FIG. 3) of the first body part 12 toward the second body part 14 (refer to FIG. 2) side. The first pin 92a can be configured to protrude from a side wall of the second recess 34 (refer to FIG. 4) of the second body part 14 toward the first body part 12 side. The first pin 92a is inserted into the first hole 90a. The first pin 92a is formed so as to fit into the first hole 90a.

The second pins 92b are formed rearward of the plurality of line eyes 58. The second pins 92b are provided rearward of the first pin 92a. The second pins 92b are formed to protrude from a side wall of the second recess 20 (refer to FIG. 3) of the first body part 12 toward the second body part 14 (refer to FIG. 2) side. The second pins 92b can be formed to protrude from a side wall of the second recess 34 (refer to FIG. 4) of the second body part 14 toward the first body part 12 side. A plurality of the second pins 92b are formed. For example, two of the second pins 92b are formed. The second pins 92b are inserted into the second holes 90b. The second pins 92b are formed so as to fit into the second holes 90b.

The restricting portion 50 restricts the movement of the plate member 6 relative to the body 4 with the first pin 92a and the second pins 92b. The restricting portion 50 can restrict the movement of the plate member 6 relative to the body 4 with only the first pin 92a, or with only the second pins 92b.

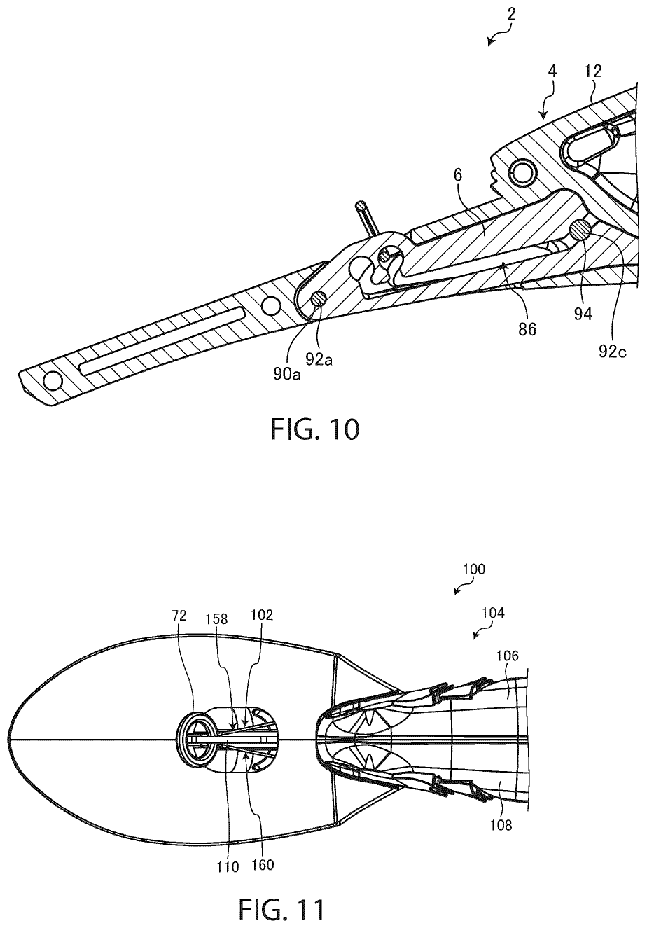

As shown in FIG. 10, a second hole 94 formed in the plate member 6 can be formed so as to include a portion of the slit 86. The second hole 94 is formed such that the slit 86 penetrates therethrough. The movement of the plate member 6 relative to the body 4 is restricted by one of the second pins 92c that is inserted into the second hole 94.

### Embodiment 2

A lure 100 according to a second embodiment will be described with reference to FIGS. 11-15. Descriptions of configurations that are the same as those of the first embodiment will be omitted. As shown in FIG. 11, the lure 100 comprises an elastic member 102. A body 104 of the lure 100 is formed by joining the first body part 106 and the second body part 108, in the same manner as in the first embodiment.

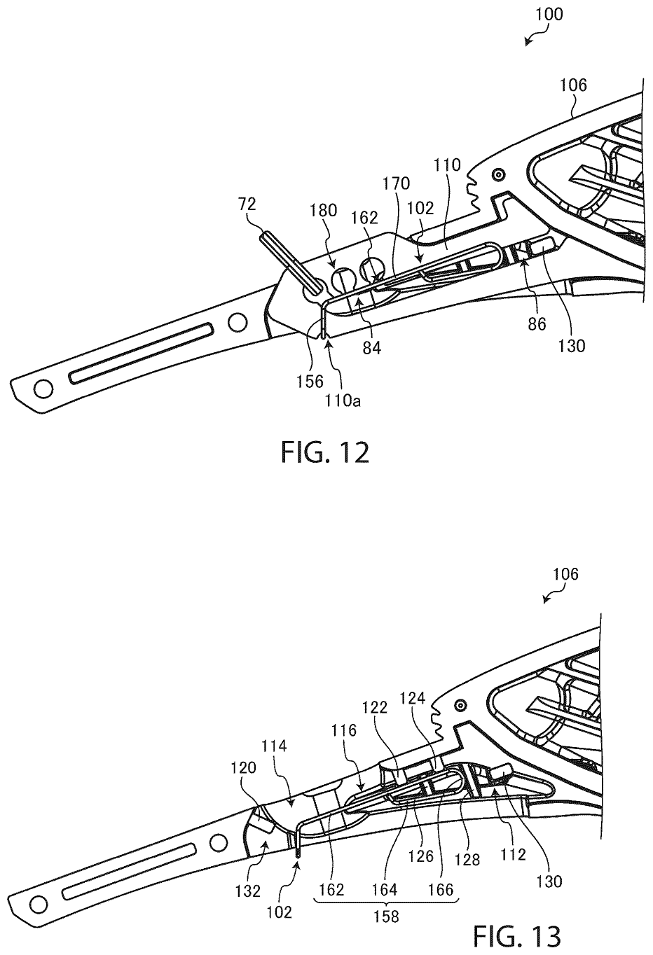

A groove 110a is formed in a plate member 110 of the lure 100 according to the second embodiment, as shown in FIG. 12. The groove 110a is formed in the plate member 110 on the front side. The groove 110a is formed at the lower end of the plate member 110. The groove 110a is formed so as to be recessed in the upward direction.

A third recess 112 on the front side of the first body part 106 is formed such that the length thereof in the upward-downward direction decreases toward the front, as shown in FIG. 13. In FIG. 13, a portion of the elastic member 102 is depicted. A first communication hole 114 of the first body part 106 is connected to the third recess 112 via a fifth communication hole 116. The first body part 106 includes a first protrusion 120, a second protrusion 122, a third protrusion 124, a fourth protrusion 126, a fifth protrusion 128, and a sixth protrusion 130.

The first protrusion 120 is formed forward of the first communication hole 114. The first protrusion 120 protrudes from a side wall of a second recess 132 toward the second body part 108 (refer to FIG. 11) side.

The second protrusion 122 is formed rearward of the first communication hole 114. The second protrusion 122 protrudes from a side wall of the second recess 132 toward the second body part 108 (refer to FIG. 11) side. The second protrusion 122 protrudes into the third recess 112.

The third protrusion 124 is formed rearward of the second protrusion 122. The third protrusion 124 protrudes from a side wall of the second recess 132 toward the second body part 108 (refer to FIG. 11) side. The third protrusion 124 protrudes into the third recess 112. The first body part 106 can include one of the second protrusion 122 and the third protrusion 124.

The fourth protrusion 126 protrudes from a side wall of the third recess 112 toward the second body part 108 (refer to FIG. 11) side. The fifth protrusion 128 is formed rearward of the fourth protrusion 126. The fifth protrusion 128 protrudes from a side wall of the third recess 112 toward the second body part 108 (refer to FIG. 11) side.

The sixth protrusion 130 is formed rearward of the fifth protrusion 128. The sixth protrusion 130 protrudes from a side wall of the second recess 132 toward the second body part 108 (refer to FIG. 11) side. As shown in FIG. 12, the sixth protrusion 130 is inserted into the slit 86 of the plate member 110.

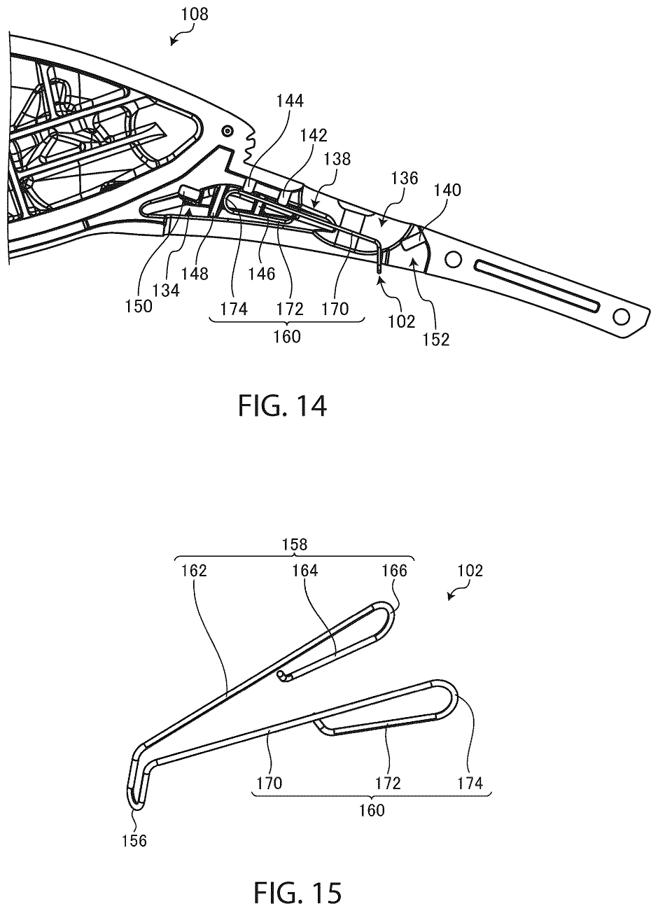

A third recess 134 on the front side of the first body part 108 is formed such that the length thereof in the upward-downward direction decreases toward the front, as shown in FIG. 14. In FIG. 14, a portion of the elastic member 102 is depicted. A first communication hole 136 of the second body part 108 is connected to the third recess 134 via a fifth communication hole 138. The second body part 108 includes a first protrusion 140, a second protrusion 142, a third protrusion 144, a fourth protrusion 146, a fifth protrusion 148, and a sixth protrusion 150.

The first protrusion 140 is formed forward of the first communication hole 136. The first protrusion 140 protrudes from a side wall of a second recess 152 toward the first body part 106 (refer to FIG. 11) side. The first protrusion 140 is formed so as to face the first protrusion 120 (refer to FIG. 13) of the first body part 106 with the plate member 110 (refer to FIG. 12) interposed therebetween.

The second protrusion 142 is formed rearward of the first communication hole 136. The second protrusion 142 protrudes from a side wall of a second recess 152 toward the first body part 106 (refer to FIG. 11) side. The second protrusion 142 is formed so as to face the second protrusion 122 (refer to FIG. 13) of the first body part 106 with the plate member 110 (refer to FIG. 12) interposed therebetween. The second protrusion 142 protrudes into the third recess 134.

The third protrusion 144 is formed rearward of the second protrusion 142. The third protrusion 144 protrudes from a side wall of the second recess 152 toward the first body part 106 (refer to FIG. 11) side. The third protrusion 144 is formed so as to face the third protrusion 124 (refer to FIG. 13) of the first body part 106 with the plate member 110 (refer to FIG. 12) interposed therebetween. The third protrusion 144 protrudes into the third recess 134. The second body part 108 can include one of the second protrusion 142 and the third protrusion 144.

The fourth protrusion 146 protrudes from a side wall of a third recess 134 toward the first body part 106 (refer to FIG. 11) side. The fifth protrusion 148 is formed rearward of the fourth protrusion 146. The fifth protrusion 148 protrudes from a side wall of the third recess 134 toward the first body part 106 (refer to FIG. 11) side.

The sixth protrusion 150 is formed rearward of the fifth protrusion 148. The sixth protrusion 150 protrudes from a side wall of a second recess 152 toward the first body part 106 (refer to FIG. 11) side. The sixth protrusion 150 is inserted into the slit 86 (refer to FIG. 12) of the plate member 110. The lure 100 can include one of the sixth protrusion 130 (refer to FIG. 13) of the first body part 106 and the sixth protrusion 150 of the second body part 108.

As shown in FIG. 15, the elastic member 102 includes a connection portion 156, a first arm portion 158, and a second arm portion 160. The connection portion 156 is formed so as to have an essentially U-shape when viewed from the forward-rearward direction.

The first arm portion 158 extends rearward from the upper end of the connection portion 156 on the right side. The first arm portion 158 is formed so as to be inclined in the rightward direction toward the rear. The second arm portion 160 extends in the rearward direction from the upper end of the connection portion 156 on the left side. The second arm portion 160 is formed so as to be inclined leftward toward the rear. That is, the first arm portion 158 and the second arm portion 160 are formed so as to widen in the left and right directions toward the rear.

The first arm portion 158 includes a first straight portion 162, a second straight portion 164, and a folded-back portion 166. The first straight portion 162 is formed extending rearward from the upper end of the connection portion 156.

The second straight portion 164 is formed below the first straight portion 162. The first straight portion 162 and the second straight portion 164 are formed such that the distance between the first straight portion 162 and the second straight portion 164 in the upward-downward direction increases toward the rear. The folded-back portion 166 is curved so as to fold back from the rear end of the first straight portion 162 to the front side. The folded-back portion 166 connects the rear end of the first straight portion 162 and the rear end of the second straight portion 164.

The second arm portion 160 includes a first straight portion 170, a second straight portion 172, and a folded-back portion 174. The first straight portion 170 is formed extending rearward from the upper end of the connection portion 156.

The second straight portion 172 is formed below the first straight portion 170. The first straight portion 170 and the second straight portion 172 are provided such that the distance between the first straight portion 170 and the second straight portion 172 in the upward-downward direction increases toward the rear. The folded-back portion 174 is formed curved so as to fold back from the rear end of the first straight portion 170 to the front side. The folded-back portion 174 connects the rear end of the first straight portion 170 and the rear end of the second straight portion 172.

As shown in FIG. 12, the elastic member 102 is provided such that the connection portion 156 straddles the lower end of the plate member 110. Specifically, the connection portion 156 is inserted into the groove 110a of the plate member 110. The connection portion 156 may be engaged with the groove 110a of the plate member 110. The first straight portions 162, 170 of the elastic member 102 are provided near the upper end of the communication hole 84, for example. As shown in FIG. 11, the first arm portion 158 is provided to the right of the plate member 110. The second arm portion 160 is provided to the left of the plate member 110. The elastic member 102 is supported by the body 104.

As shown in FIG. 13, a portion of the first arm portion 158 of the elastic member 102 is accommodated in the third recess 112 of the first body part 106. Specifically, a portion of the first straight portion 162, the second straight portion 164, and the folded-back portion 166 of the first arm portion 158 are accommodated in the third recess 112. As shown in FIG. 14, a portion of the second arm portion 160 of the elastic member 102 is accommodated in the third recess 134 of the second body part 108. Specifically, a portion of the first straight portion 170, the second straight portion 172, and the folded-back portion 174 of the second arm portion 160 are accommodated in the third recess 134.

As shown in FIG. 13, the first straight portion 162 of the first arm portion 158 is accommodated in the third recess 112 and abuts against the lower end surface of the second protrusion 122 of the first body part 106 and the lower end surface of the third protrusion 124 of the first body part 106. The second straight portion 164 abuts against the bottom surface of the third recess 112 of the first body part 106. As shown in FIG. 14, the first straight portion 170 of the second arm portion 160 accommodated in the third recess 134 abuts against the lower end surface of the second protrusion 142 of the second body part 108 and the lower end surface and the third protrusion 144 of the second body part 108. The second straight portion 172 of the second arm portion 160 abuts against the bottom surface of the third recess 134 of the second body part 108. That is, the elastic member 102 is supported by the second protrusions 122, 142, the third protrusions 124, 144, and the third recesses 112, 134 in the upward-downward direction. The forward movement of the elastic member 102 is restricted by the second protrusions 122, 142 and the third protrusions 124, 144.

The first straight portion 162 and/or the second straight portion 164 (refer to FIG. 13) of the first arm portion 158 accommodated in the third recess 112 abuts against the left end surface of the fourth protrusion 126 (refer to FIG. 13) of the first body part 106. The first straight portion 170 and/or the second straight portion 172 (refer to FIG. 14) of the second arm portion 160 accommodated in the third recess 134 abuts against the right end surface of the fourth protrusion 146 (refer to FIG. 14) of the second body part 108. That is, the elastic member 102 is supported by the fourth protrusions 126, 146 in the left-right direction.

As shown in FIG. 13, the rear-end portion of the folded-back portion 166 of the first arm portion 158 abuts against the front end surface of the fifth protrusion 128 of the first body part 106. As shown in FIG. 14, the rear-end portion of the folded-back portion 174 of the second arm portion 160 abuts against the front end surface of the fifth protrusion 148 of the second body part 108. The rearward movement of the elastic member 102 is restricted by the fifth protrusions 128, 148.

As shown in FIG. 12, the elastic member 102 is configured to suppress the movement of the ring member 72 into the communication hole 84. The elastic member 102 suppresses the movement of the ring member 72 from the plurality of line eyes 180 to the communication hole 84. For example, when the ring member 72 abuts against the elastic member 102 during use of the lure 100, the movement of the ring member 72 to the communication hole 84 is suppressed by the elastic member 102. For example, when the elastic member 102 is pushed downward by the ring member 72 during use of the lure 100, a biasing force that pushes the ring member 72 upward is generated in the elastic member 102. Therefore, the movement of the ring member 72 into the communication hole 84 is suppressed by the elastic member 102. That is, the ring member 72 is suppressed from moving between the plurality of line eyes 180 during use of the lure 100.

When changing the line eye 180 to which the ring member 72 is attached, the user brings the ring member 72 in contact with the elastic member 102 and pushes the ring member 72 toward the communication hole 84 side against the biasing force of the elastic member 102. When the ring member 72 is pressed toward the communication hole 84 side, the elastic member 102 is elastically deformed. For example, the elastic member 102 elastically deforms such that the front side curves downward. The ring member 72 is thereby inserted into the communication hole 84. Next, the user moves the ring member 72 along the communication hole 84 and inserts the ring member 72 into the line eye 180 from the communication hole 84. In this manner, the user changes the line eye 180 to which the ring member 72 is attached via the communication hole 84. When the ring member 72 is inserted into the line eye 180, the elastic member 102 returns to the original state.

The body 104 sandwiches the plate member 110 from the left and right directions with the first protrusions 120, 140. The first protrusions 120, 140 sandwich the plate member 110 on the front side of the plurality of line eyes 180. That is, the first protrusions 120, 140 constitute the first restricting part 52.

The body 104 sandwiches the plate member 110 from the left and right directions with the second protrusions 122, 142 and the third protrusions 124, 144. The second protrusions 122, 142 and the third protrusions 124, 144 sandwich the plate member 110 on the rear side of the plurality of line eyes 180. That is, the second protrusions 122, 142 and the third protrusions 124, 144 constitute the second restricting part 54.

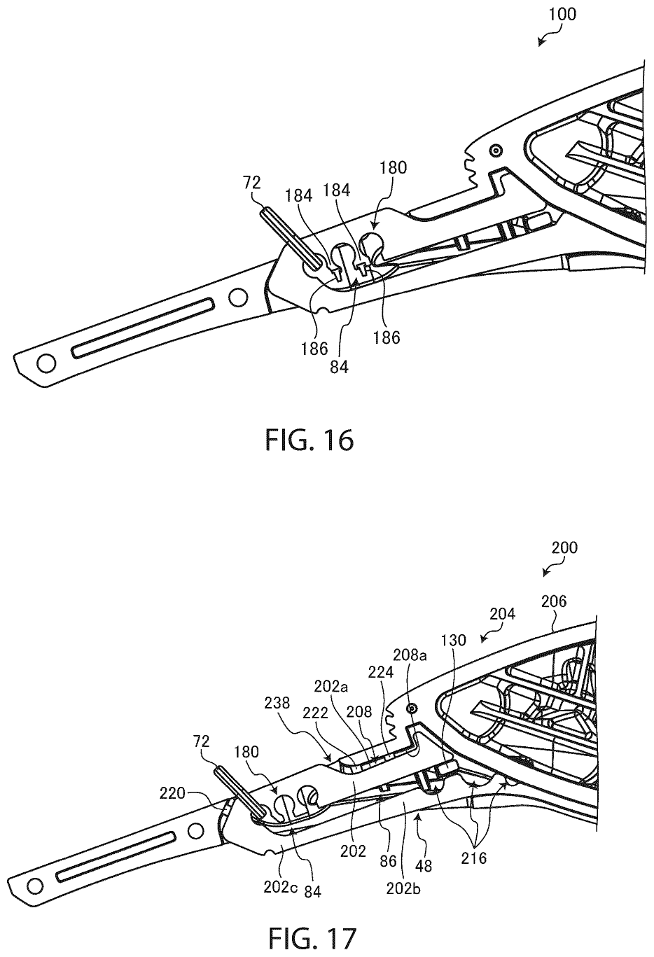

The lure 100 according to a modified example can be provided with an elastic body 186 at the lower end of a partition wall 184, as shown in FIG. 16. The elastic body 186 is configured to protrude into the communication hole 84. The elastic body 186 is configured to protrude into the communication hole 84 from the lower end of the partition wall 184, for example. The elastic body 186 is, for example, rubber.

The elastic body 186 comes in contact with the ring member 72 when the ring member 72 passes. When the ring member 72 is inserted into the communication hole 84 during use of the lure 100, the elastic body 186 prevents the ring member 72 from moving between the plurality of line eyes 180. When changing the line eye 180 to which the ring member 72 is attached, the user moves the ring member 72 against the elastic force of the elastic body 186 to change the line eye 180 to which the ring member 72 is attached.

### Embodiment 3

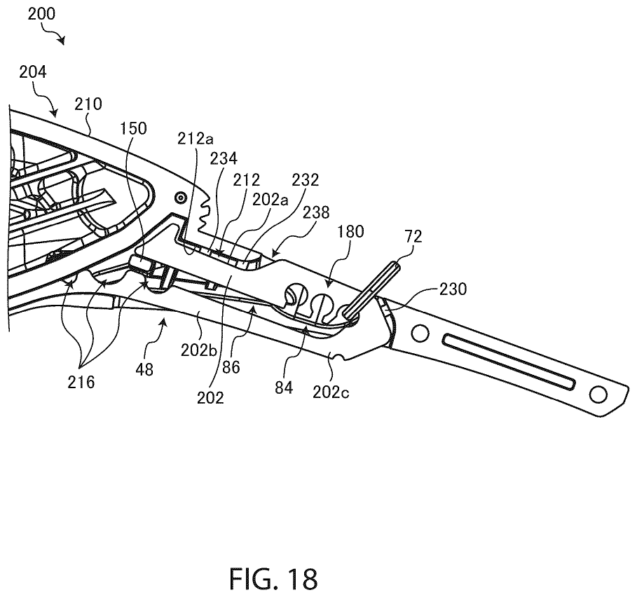

A lure 200 according to a third embodiment will be described with reference to FIGS. 17 and 18. Descriptions of configurations that are the same as the first embodiment or the second embodiment are omitted.

A plate member 202 of the lure 200 according to the third embodiment is elastically deformable in the upward-downward direction relative to a body 204. Specifically, the plate member 202 is elastically deformable upward relative to the body 204. As shown in FIG. 17, a gap is formed between an upper wall surface 208a of a second recess 208 of a first body part 206 and an upper surface 202a of the plate member 202 facing the upper wall surface 208a. As shown in FIG. 18, a gap is formed between an upper wall surface 212a of a second recess 212 of a second body part 210 and the upper surface 202a of the plate member 202 facing the upper wall surface 212a.

A plurality of recesses 216 are formed in the plate member 202. The plurality of recesses 216 are formed in a lower piece 202b. The lower piece 202b is the lower-side portion of the plate member 202 forming the slit 86. The plurality of recesses 216 are arranged side by side in the forward-rearward direction. The plurality of recesses 216 are formed so as to be recessed downward. For example, three of the recesses 216 are formed. The number of the recesses 216 may be two. The number of the recesses 216 may be four or more.

An end 202c of the plate member 202 on the side opposite to the plurality of line eyes 180 in the upward-downward direction protrudes downward from the body 204. Specifically, the lower-side end 202c of the plate member 202 on the front side protrudes downward from the second communication hole 48

A first protrusion 220, a second protrusion 222, and a third protrusion 224 shown in FIG. 17 are formed such that the plate member 202 can be elastically deformed in the upward-downward direction relative to the body 204. For example, the first protrusion 220, the second protrusion 222, and the third protrusion 224 are formed such that a small gap is formed between the protrusions and the plate member 202. If the plate member 202 is elastically deformable in the upward-downward direction relative to the body 204, at least one of the first protrusion 220, the second protrusion 222, and the third protrusion 224 can abut against the plate member 202. The first protrusion 220, the second protrusion 222, and the third protrusion 224 are formed so as to suppress the movement of the plate member 202 relative to the body 204 in the left-right direction.

A first protrusion 230, a second protrusion 232, and a third protrusion 234 shown in FIG. 18 are formed such that the plate member 202 can be elastically deformed in the upward-downward direction relative to the body 204. For example, the first protrusion 230, the second protrusion 232, and the third protrusion 234 are formed such that a small gap is formed between the protrusions and the plate member 202. If the plate member 202 is elastically deformable in the upward-downward direction relative to the body 204, at least one of the first protrusion 230, the second protrusion 232, and the third protrusion 234 can abut against the plate member 202. The first protrusion 230, the second protrusion 232, and the third protrusion 234 are formed so as to suppress the movement of the plate member 202 relative to the body 204 in the left-right direction.

When changing the line eye 180 to which the ring member 72 is attached, the user pushes up the end 202c of the plate member 202 protruding in the downward direction from the body 204. As a result, the plate member 202 on the front side is elastically deformed so as to curve upward. The plate member 202 is elastically deformed by being bent from the vicinity of the location where the plurality of recesses 216 are formed. As a result of the plate member 202 on the front side curving upward, the plurality of line eyes 180 move in the upward direction relative to the body 204. For example, at least some of the plurality of line eyes 180 protrude upward from a first communication hole 238.

As shown in FIG. 17 or 18, the body 204 has the sixth protrusions 130, 150 that are inserted into the slit 86. Therefore, even if the plate member 202 is elastically deformed, the width of the slit 86 is prevented from becoming too narrow. That is, even if the plate member 202 is elastically deformed, the width of the communication hole 84 is prevented from becoming too narrow.

The user changes the line eye 180 to which the ring member 72 is attached via the communication hole 84 while maintaining a state in which the plurality of line eyes 180 have been moved upward relative to the body 204. When the upward pressure is released, the plate member 202 returns to the original state.

As used in the present Specification, the phrase “at least one” means “one or more” of desired options. As an example, the phrase “at least one” as used in the present Specification means, if the number of options is two, “only one of the options” or “both of the two options.” As another example, the phrase “at least one” as used in the present Specification means, if the number of options is three or more, “only one of the options” or “any combination of two or more of the options.”

What is claimed is:

1. A lure, comprising:
a plurality of line eyes configured to have a line connected thereto, the plurality of line eyes connected to each other via a communication hole.

2. The lure according to claim 1, wherein
the communication hole is connected to lower ends of the plurality of line eyes.

3. The lure according to claim 1, further comprising
at least one partition wall formed between the plurality of line eyes and configured to separate the plurality of line eyes,
a length of the at least one partition wall in an upward-downward direction is shorter than an inner diameter of a ring member configured to connect the plurality of line eyes and the line.

4. The lure according to claim 1, further comprising
at least one partition wall formed between the plurality of line eyes and configured to separate the plurality of line eyes,
the at least one partition wall having a protrusion protruding in a forward-rearward direction from a lower end thereof.

5. The lure according to claim 1, further comprising
at least one partition wall formed between the plurality of line eyes and configured to separate the plurality of line eyes,
each of the line eyes having a protrusion protruding toward the at least one partition wall.

6. The lure according to claim 1, further comprising
a plate member including the plurality of line eyes, and
a body to which the plate member is attached,
a slit connected to the communication hole formed in the plate member, and
the slit is enclosed in the body.

7. The lure according to claim 1, further comprising
a plate member including the plurality of line eyes,
a body to which the plate member is attached, and
an elastic member supported by the body,
the elastic member configured to prevent a ring member connecting the line and a line eye of the plurality of line eyes from moving to the communication hole.

8. The lure according to claim 1, further comprising
an elastic body configured to protrude into the communication hole.

9. The lure according to claim 1, further comprising
a plate member including the plurality of line eyes, and
a body to which the plate member is attached,
the plate member elastically deformable in the upward-downward direction with respect to the body.

10. The lure according to claim 9, wherein
an end of the plate member on the side opposite to the plurality of line eyes in the upward-downward direction protrudes downward from the body.

11. The lure according to claim 9, wherein
a slit is connected to the communication hole and is formed in the plate member, and
the body has a protrusion inserted into the slit.

12. The lure according to claim 9, wherein
a slit is connected to the communication hole and is formed in the plate member, and
a plurality of recesses are formed in a lower piece of the plate member in which the slit is formed.
